(19) United States
(12) Patent Application Publication
(10) Pub. No.: US 2026/0340504 A1
(43) Pub. Date: Oct. 29, 2026

(54) METHOD AND APPARATUS FOR AUTOMATING TECHNIQUES USING LARGE LANGUAGE MODELS FOR LABELED DATASET CREATION BASED ON GROUND TRUTH DATASET

(71) Applicant: PRICEWATERHOUSECOOPERS LLP, Toronto (CA)

(72) Inventors: Michelle BOURGEOIS, Toronto (CA); Vik PANT, Tampa, FL (US)

(21) Appl. No.: 19/657,692

(22) Filed: Apr. 24, 2026

(30) Foreign Application Priority Data
Apr. 24, 2025 (CA) 3271765

(51) Int. Cl. G06N 20/00

(52) U.S. Cl. CPC G06N 20/00

(57) ABSTRACT

A System and method are disclosed for automated dataset creation and expansion using large language models (LLMs). The method for dataset creation involves generating counterfactual examples that reflect incorrect or undesirable responses to prompts using a: source LLM, labeling these examples as negative, and using them to tune or test a target LLM to mitigate similar outputs. The method for dataset expansion uses a source LLM to generate semantically equivalent variations of prompts and completions from an existing dataset, which are then used to create new prompt-completion pairs by combining original and perturbed elements: These expanded pairs are employed to tune or test a target LLM to recognize semantic equivalence across diverse phrasings. A system implementing these methods includes a source LLM, a semantic analysis component to measure similarity between original and generated examples, a dataset management module for handling labeled data, and a target LLM for tuning and testing. The invention supports the use of embedding-based distance metrics and semantic similarity thresholds to ensure quality and control in dataset generation.

### FIELD OF THE INVENTION

The present invention relates to computer-implemented systems and methods for automated data labeling in artificial intelligence, specifically techniques that utilize large language models (LLMs) to create labeled datasets based on ground truth dataset for tuning and testing other large language models, among other possible applications.

### BACKGROUND OF THE INVENTION

Large language models have demonstrated remarkable capabilities in natural language understanding and generation. However, their effectiveness is heavily dependent on the quality and diversity of labeled data. Creating high-quality labeled datasets manually is labor-intensive, expensive, and often fails to capture the full spectrum of language variations and edge cases necessary for robust model performance.

Current practices often rely on human annotators to create labeled examples, which introduces several limitations:

High cost and time requirements
1. Limited scale and coverage
2. Potential for annotator bias
3. Difficulty creating adversarial examples
4. Challenges in maintaining consistency across large datasets

This invention addresses one or more of the following challenges:
1. Reducing the time and cost associated with creating labeled datasets
2. Expanding the diversity and coverage of labeled examples
3. Generating high-quality counterfactual examples that help models learn decision boundaries
4. Creating semantically meaningful perturbations that enhance model robustness
5. Automating the creation of edge cases and corner cases that human annotators might miss

### SUMMARY OF THE INVENTION

The present invention is a computer-implemented system and a method using large language models to automatically generate labeled datasets for tuning and testing target large language models, in the context of chatbot applications but for other applications as well. The invention leverages the capabilities of existing LLMs to create diverse, semantically relevant examples that enhance the performance and robustness of target LLMs.

As embodied and broadly described herein, the invention provides a computer-implemented method for automated dataset creation using a large language model, comprising:
a. utilizing a source large language model to generate counterfactual examples that represent incorrect or undesirable responses to given prompts;
b. labeling these counterfactual examples as negative examples;
c. using the negative examples to tune or test a target large language model to avoid generating semantically similar responses.

As embodied and broadly described herein, the invention provides a computer-implemented method for automated dataset expansion using a large language model, comprising:
a. Utilizing a source large language model to generate semantically equivalent variations of prompts and completions from an existing dataset;
b. Creating new prompt-completion pairs by combining original and perturbed elements;
c. Using the new prompt-completion pairs to tune and test a target large language model to recognize semantic equivalence across different phrasings.

Both aspects are designed to overcome at least in part limitations of manually created datasets by automatically generating examples that explore the semantic space around ground truth data points, enabling more robust model tuning and testing.

### BRIEF DESCRIPTION OF THE DRAWINGS

FIG. 1 illustrates the system architecture for automated LLM Dataset Creation utilizing existing LLM's to generate training data, creating both counterfactual examples and perturbed variations.

FIG. 2 is a flow chart that illustrates an example of negative reinforcement learning process through counterfactual examples from method 1 in FIG. 1.

FIG. 3 is a flow chart that illustrates an example of contrastive learning process with perturbed prompts and completions indicated by method 2 in FIG. 1.

FIG. 4 illustrates an embedding-based distance metrics for semantic proximity.

FIG. 5 illustrates an embedding-based distance metrics chart for semantic proximity from FIG. 4 with an emphasis on a block diagram depicting the technical architecture for embedding distance measurement.

FIG. 6 is a block diagram that illustrates at a high level an implementation example of a customer service chatbot as a practical application of automated labeling techniques according to the present invention.

### DESCRIPTION OF AN EXAMPLE OF IMPLEMENTATION

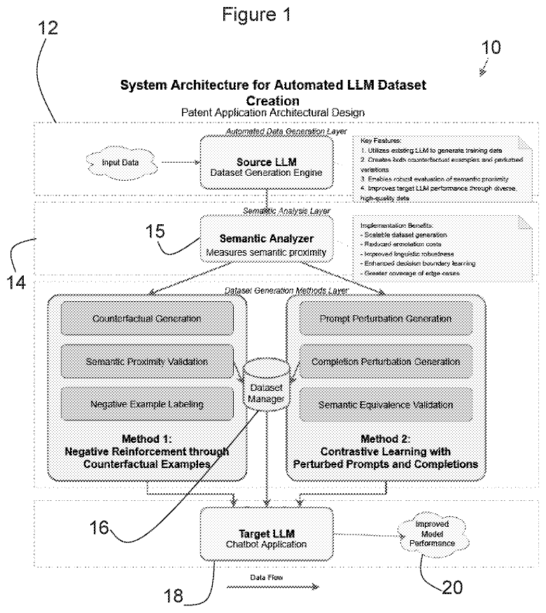

FIG. 1 illustrates a high-level system architecture 10 for automated creation of training and evaluation datasets for large language models. The system architecture 10 comprises an automated data generation layer 12 configured to receive input data including, without limitation, seed prompt-completion pairs, domain-specific corpora, interaction logs, or other structured or unstructured textual inputs. The automated data generation layer 12 is operatively coupled to a semantic analyzer layer 14, which evaluates semantic properties of generated outputs, including semantic similarity, divergence, and contextual alignment relative to reference data.

The semantic analyzer layer 14 includes a semantic analyzer module 15 configured to operate on representations of prompts and completions generated by one or more source language models, and to produce quantitative or qualitative assessments of semantic proximity. Based on these assessments, the system architecture 10 selectively applies one or more dataset generation methods. In a first method, identified herein as Method 1, negative reinforcement training data is generated through counterfactual examples. In a second method, identified herein as Method 2, contrastive learning data is generated through perturbed prompts and perturbed completions. A dataset manager 16 governs invocation, weighting, sequencing, and combination of Method 1 and Method 2, thereby controlling the composition and balance of the resulting dataset. The output of the dataset manager 16 is provided as training, tuning, or evaluation input to a target large language model 18, a chatbot application 20, or another downstream machine-learning-based application.

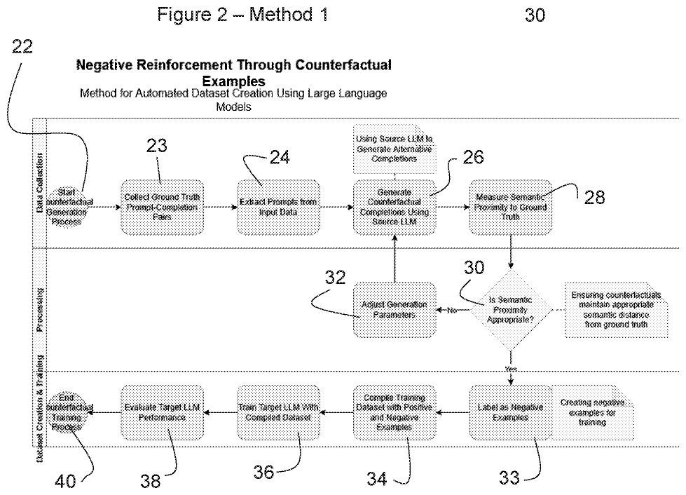

FIG. 2 illustrates a process flow 22 corresponding to Method 1, namely negative reinforcement through counterfactual examples. In this method, a source language model is employed to generate intentionally incorrect, misleading, incomplete, or otherwise undesirable responses for prompts whose ideal or ground-truth responses are known. The method begins with collection of a set of prompt-completion pairs representing desired or ideal interactions for the target language model. These prompt-completion pairs may be curated by human experts, derived from validated logs, or sourced from authoritative datasets.

For each prompt, the source language model generates one or more counterfactual completions that are semantically related to the prompt but fail to satisfy one or more quality criteria, such as correctness, helpfulness, appropriateness, tone, or domain relevance. The semantic analyzer 14 constrains generation of such counterfactual completions by enforcing semantic proximity requirements, ensuring that each counterfactual is sufficiently close to the ground-truth completion to be plausible and challenging, yet sufficiently distinct to clearly represent an error case. The original ground-truth completions are labeled as positive examples, while the generated counterfactual completions are labeled as negative examples. These labeled examples are aggregated to form a composite dataset that teaches the target language model 18 not only what constitutes a correct response, but also what constitutes an incorrect or suboptimal response within a similar semantic space.

By way of illustrative example, for a customer service chatbot application, the prompt “I need to reset my password but the reset link isn't working” may have an ideal completion that provides empathetic, procedural assistance and offers corrective actions. Counterfactual completions generated for the same prompt may include responses that are overly technical and inaccessible, responses that are vague or dismissive, or responses that provide factually incorrect guidance. Although each counterfactual completion is topically related to the prompt, such responses fail to meet the quality threshold expected of the application. Inclusion of these counterfactuals as negative examples enables the target language model 18 to learn decision boundaries between acceptable and unacceptable responses without exposing end users to such failures in a production environment.

More specifically, reference is now made to FIG. 2, which illustrates a method for automating counterfactual dataset creation and model training in accordance with one or more embodiments of the present disclosure. The method depicted in FIG. 2 comprises three principal segments, namely a data collection segment, a processing segment, and a dataset creation and training segment, each of which will be described in greater detail hereinbelow.

The data collection segment initiates the counterfactual generation process at step 22. In a first step 23, a plurality of ground-truth prompt-completion pairs are collected from one or more data sources. The ground-truth prompt-completion pairs represent known, verified examples of input prompts and their corresponding correct completions, which serve as a baseline reference for subsequent counterfactual generation and semantic evaluation operations. It will be appreciated that the quality and representativeness of the ground-truth prompt-completion pairs collected at step 23 may have a material influence on the fidelity of the counterfactual examples generated in downstream processing steps.

At step 24, the prompts are extracted from the collected ground-truth prompt-completion pairs. The extraction process isolates the input prompts from their associated ground-truth completions, thereby preparing the extracted prompts for use as input stimuli in the counterfactual generation phase. In certain embodiments, the extraction at step 24 may further include preprocessing operations such as normalization, tokenization, or formatting of the extracted prompts to ensure compatibility with the source large language model (LLM).

Proceeding to the processing segment, at step 26, the source LLM is employed to generate one or more counterfactual examples based on the extracted prompts obtained at step 24. The counterfactual examples represent alternative completions that differ from the ground-truth completions while being responsive to the same input prompts. The source LLM generates these counterfactual completions by processing the extracted prompts in accordance with its current generation parameters, which may include, without limitation, temperature settings, sampling strategies, and other hyperparameters governing the stochastic behavior of the model's output distribution.

At step 28, the semantic proximity of each generated counterfactual example to the corresponding ground-truth completion is measured. The semantic proximity measurement quantifies the degree of semantic similarity or divergence between the counterfactual completion produced by the source LLM and the ground-truth completion associated with the same input prompt. In various embodiments, the semantic proximity may be determined using one or more distance metrics or similarity measures applied in an embedding space, such as cosine similarity, Euclidean distance, or other suitable vector-based comparison techniques known in the art.

At decision step 30, a determination is made as to whether the measured semantic proximity falls within an acceptable semantic proximity window. The acceptable semantic proximity window defines a range of semantic distance values within which the counterfactual examples are deemed to be sufficiently distinct from the ground-truth completions to serve as meaningful negative examples, while remaining sufficiently related to the input prompts so as to provide pedagogically useful training signals for the target LLM.

In the event that decision step 30 is answered in the negative, indicating that the semantic proximity of the generated counterfactual examples does not fall within the acceptable semantic proximity window, the method proceeds to step 32, wherein the generation parameters of the source LLM are adjusted. The adjustment of the generation parameters at step 32 may include, without limitation, the modification of existing prompts supplied to the source LLM, the generation of new or supplementary prompts, the alteration of temperature or sampling parameters, or any combination thereof. These adjustments are configured to drive the output of the source LLM such that subsequently generated counterfactual completions fall within the acceptable semantic proximity window established at decision step 30. Following the adjustment at step 32, the method returns to step 26, wherein the source LLM generates revised counterfactual examples using the adjusted generation parameters, thereby forming an iterative feedback loop that continues until the semantic proximity criterion is satisfied.

Conversely, in the event that decision step 30 is answered in the affirmative, indicating that the measured semantic proximity is adequate and falls within the acceptable semantic proximity window, the method proceeds to step 33, which forms part of the dataset creation and training segment. At step 33, the counterfactual examples that have satisfied the semantic proximity criterion are labeled as negative examples. The designation of the counterfactual completions as negative examples distinguishes them from the ground-truth completions, which are correspondingly designated as positive examples, thereby establishing a binary classification framework suitable for supervised training of the target LLM.

At step 34, the training dataset is compiled by aggregating both the positive examples derived from the ground-truth prompt-completion pairs and the negative examples derived from the labeled counterfactual completions generated and validated through the preceding steps. The compiled training dataset thus comprises a structured collection of prompt-completion pairs, each bearing a corresponding label indicating whether the completion represents a ground-truth positive example or a counterfactual negative example.

At step 36, the target LLM is trained using the compiled training dataset assembled at step 34. The training at step 36 leverages the juxtaposition of positive and negative examples within the compiled dataset to refine the target LLM's ability to discriminate between correct and incorrect completions, thereby enhancing the target LLM's performance in generating accurate and contextually appropriate responses to input prompts.

In certain embodiments, at optional step 38, the performance of the target LLM is evaluated following the training performed at step 36. The evaluation at step 38 may employ one or more evaluation metrics or benchmark datasets to assess the degree to which the training has improved the target LLM's generative accuracy, robustness, and overall task performance. It will be understood that step 38 is optional and may be omitted in embodiments where post-training evaluation is not required or is deferred to a subsequent stage of the development pipeline. The method concludes at step 40.

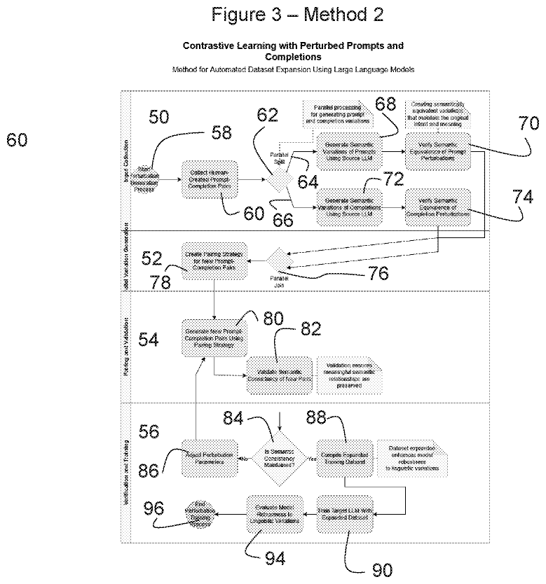

FIG. 3 illustrates a process flow 24 corresponding to Method 2, namely contrastive learning with perturbed prompts and completions. In contrast to Method 1, which focuses on negative examples, Method 2 focuses on generating semantically equivalent but linguistically varied examples to enhance robustness and generalization. The method begins with collection of a baseline dataset of high-quality promt-completion pairs, optionally authored or validated by humans.

Using a source language model, such as the model at layer 12, the system generates perturbed versions of each prompt that preserve the original intent while introducing variations in phrasing, vocabulary, syntactic structure, or level of detail. Similarly, perturbed versions of each completion are generated that preserve informational content and helpfulness while expressing the same response using alternative linguistic formulations. New prompt-completion pairs are created by pairing original prompts with perturbed completions, perturbed prompts with original completions, and perturbed prompts with perturbed completions. Each resulting pair is evaluated by the semantic analyzer 14 to confirm that semantic equivalence and quality standards are maintained.

For example, an original prompt querying the difference between a debit card and a credit card may yield multiple paraphrased prompts expressing the same question in different ways, and multiple paraphrased completions explaining the same financial distinction using alternative wording. By incorporating these variations into the dataset, the target language model 18 is trained to focus on semantic meaning rather than surface-level phrasing, thereby improving performance on novel user inputs that differ from previously observed formulations.

The process at FIG. 3 is partitioned into a plurality of functional segments, including an input collection segment 50, a parallel validation and generation segment 52, a pairing and validation segment 54, and a verification and training segment 56. Each segment may be implemented as one or more software modules, hardware components, or combinations thereof, and may be executed sequentially, concurrently, or in a partially overlapping manner depending on the system configuration. The perturbation generation process is initiated at step 58.

At step 60, prompt-completion pairs are obtained and collected for processing. Such prompt-completion pairs may be generated by human authors, automatically generated, synthetically produced, or derived from prior system interactions. In one exemplary implementation, prompt-completion pairs are dynamically captured during interactions between a large language model (LLM) and a human user. For example, the system infrastructure may provide a graphical user interface mechanism enabling a user to explicitly or implicitly indicate that a generated response to a prompt is satisfactory or suitable for reuse. Upon such indication, the prompt and the corresponding completion produced by the LLM are recorded as a prompt-completion pair and supplied as input at step 60. The collected prompt-completion pairs may additionally be filtered, normalized, or annotated with metadata prior to further processing.

At step 62, the collected prompt-completion pairs are provided to a plurality of parallel processing channels 64 and 66. Parallelization enables independent and scalable processing of prompts and completions, thereby improving throughput and supporting higher-volume dataset expansion. In processing channel 64, step 68 generates semantic variations of the prompts, for example by invoking the same or a different source LLM to produce prompt perturbations. Such perturbations may include paraphrases, rephrasings, syntactic transformations, or other controlled semantic modifications that preserve intended meaning. At step 70, the generated prompt perturbations are evaluated to determine semantic equivalence with the original prompts. Semantic equivalence may be assessed using embedding similarity, classifier-based evaluation, rule-based constraints, or combinations thereof. Prompt perturbations that fall outside a specified semantic equivalence threshold or window are rejected from further processing.

In parallel, processing channel 66 performs step 72, in which semantic variations of the completions are generated, for example using the source LLM or a specialized completion-perturbation model. The completion perturbations may include alternative phrasings, stylistic variations, or structurally distinct responses that retain equivalent semantic content. At step 74, the semantic equivalence of the completion perturbations is evaluated to determine whether each perturbation satisfies a semantic equivalence threshold or window. The threshold or window may be dynamically or statically configurable to accommodate different target applications, model sensitivities, or desired levels of semantic diversity. Completion perturbations that do not meet the equivalence criteria are discarded.

The approved prompt variations and completion variations are combined at step 76 to form a candidate set of prompts and completions. At step 78, a pairing strategy for the candidate set is determined. The pairing strategy may define one-to-one, one-to-many, or many-to-many mappings between prompt variations and completion variations, and may be informed by semantic similarity scores, diversity objectives, structural constraints, or predefined heuristics. At step 80, new prompt-completion pairs are generated in accordance with the determined pairing strategy.

At step 82, each newly generated prompt-completion pair is subjected to a validation process to assess semantic consistency between the prompt and the associated completion. The validation may include semantic alignment checks, coherence evaluation, contradiction detection, or task-specific acceptability criteria. A determination of semantic consistency or acceptability is made at decision step 84. If semantic consistency is not satisfied, as indicated by a negative outcome at decision step 84, processing continues to step 86, where one or more perturbation parameters, thresholds, or pairing constraints are adjusted. A control or feedback signal is then propagated to step 80 to regenerate prompt-completion pairs under the updated parameters.

If semantic consistency is satisfied, processing proceeds to step 88, at which an expanded training dataset comprising validated prompt-completion pairs is compiled. The expanded training dataset is then used to train or fine-tune a target LLM at step 90. Following training, the target LLM is evaluated at step 92 to assess robustness, generalization, sensitivity to perturbations, and one or more additional performance parameters. The process terminates at step 94.

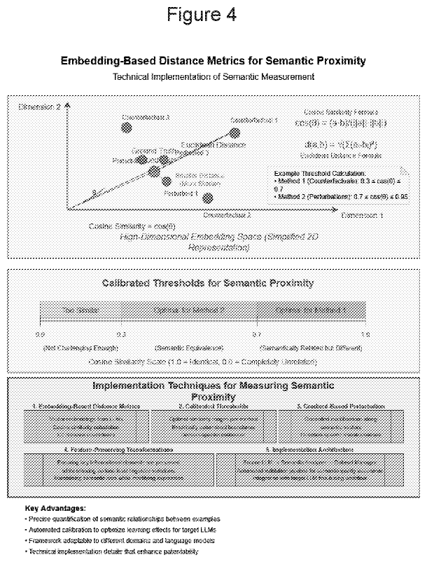

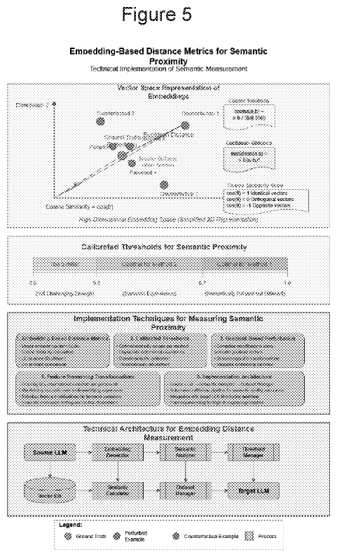

FIGS. 4 and 5 illustrate technical details of semantic proximity measurement 26 employed by the system architecture 10. One aspect of both Method 1 and Method 2 is the ability to measure, control, and enforce semantic distance between original examples and generated variations. In the illustrated implementations, textual inputs are transformed into vector embeddings, for example using embedding models associated with large language models or other neural encoders. Semantic similarity is computed using distance metrics such as cosine similarity or other vector-space measures, as shown by the graphs at the top of FIG. 4 and FIG. 5. Calibrated threshold parameters, as shown at the panel in the middle of FIGS. 4 and 5, are established to define acceptable similarity ranges/thresholds for counterfactuals and perturbations, allowing the system to differentiate between near-miss errors, acceptable paraphrases, and unrelated content.

In certain embodiments, semantic control is further refined using gradient-based perturbation techniques, in which controlled modifications are applied along semantic dimensions to incrementally adjust meaning. Feature-preserving transformations ensure that key informational elements, such as entities, intents, or constraints, are maintained even as linguistic surface forms are altered. The panel at the bottom of FIGS. 4 and 5 identify certain implementation techniques that can be used to measure semantic proximity.

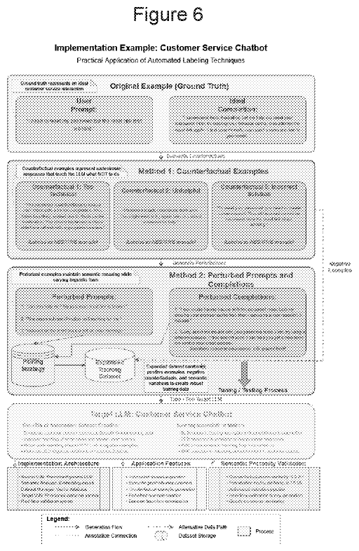

FIG. 6 illustrates an example implementation for a customer service chatbot application according to an example of implementation of the disclosed invention, providing specific implementation details. In this example, Methods 1 and 2 are sequentially invoked to train the target LLM.

Compared to manual labeled dataset creation, the automated techniques disclosed herein provide substantial advantages. The system architecture 10 enables rapid and scalable generation of large volumes of labeled data with reduced cost and minimal human intervention. Consistency is improved by eliminating inter-annotator variability, while systematic exploration of edge cases and semantic boundaries improves robustness. Datasets can be rapidly regenerated or adapted as application requirements evolve, and domain-specific datasets can be produced by conditioning the source language model on relevant contexts.

In various embodiments, the systems and methods disclosed herein may be implemented by one or more data processing systems comprising any suitable combination of hardware, firmware, and software. By way of non-limiting example, the disclosed functionality may be embodied in one or more server computers, cloud-computing platforms, virtualized computing environments, containerized execution environments, enterprise application servers, workstation computers, edge-computing devices, or distributed computing infrastructures operatively connected through one or more wired and/or wireless communication networks. The one or more data processing systems may include one or more processors, microprocessors, graphical processing units (GPUs), tensor processing units (TPUs), neural processing units (NPUs), digital signal processors, memory devices, persistent storage devices, network interfaces, and input/output interfaces, all configured to cooperate in carrying out the operations described herein. In some embodiments, the disclosed functionality may be implemented as machine-readable and/or machine-executable instructions stored on one or more non-transitory computer-readable media, which, when executed by one or more processors, cause the one or more processors to perform operations including, without limitation, receiving prompt-completion data, extracting prompts, generating counterfactual and/or perturbed examples, generating vector embeddings, computing semantic similarity or semantic distance metrics, enforcing semantic thresholds or windows, validating generated prompt-completion pairs, compiling training or evaluation datasets, training, fine-tuning, tuning, testing, evaluating, and/or deploying a target language model, and providing generated outputs to downstream applications.

In certain implementations, the disclosed system may be architected as a plurality of interoperating components, layers, engines, modules, services, or microservices, including, without limitation, an automated data generation layer, a semantic analyzer layer, a semantic analyzer module, a dataset management module, one or more model-serving components, one or more orchestration or workflow-control components, one or more data repositories, and one or more application interface components. Such components may be deployed on a single machine or distributed across multiple machines, nodes, regions, or cloud tenants, and may execute sequentially, concurrently, iteratively, or in partially overlapping fashion depending on the desired throughput, latency, scalability, fault tolerance, or deployment architecture. In some embodiments, the system may further interface with one or more relational databases, document stores, vector databases, feature stores, model registries, logging systems, monitoring systems, application programming interfaces (APIs), and user-interface systems, including graphical user interfaces configured to capture human approval, rejection, annotation, feedback, or validation signals associated with generated prompt-completion pairs or other intermediate outputs.

The source large language model and the target large language model described herein may each be implemented using any suitable artificial intelligence or machine-learning architecture capable of natural language understanding and/or generation. In some embodiments, one or both of the source large language model and the target large language model may comprise transformer-based generative artificial intelligence technologies, including decoder-only models, encoder-decoder models, encoder-based models adapted for generation or semantic representation, foundation models, fine-tuned foundation models, domain-adapted language models, instruction-tuned language models, distilled models, retrieval-augmented models, and/or ensembles or cascades thereof. In certain embodiments, the semantic analysis functionality may be performed by the same generative model used for example generation, by a separate embedding model, by another neural encoder, by a classifier-based semantic evaluator, or by a hybrid arrangement combining multiple models and rule-based controls. The disclosed system is therefore not limited to any particular model vendor, training paradigm, deployment topology, or inference framework, and may be implemented using proprietary, open-source, on-premises, cloud-hosted, or hybrid model infrastructure.

In further embodiments, the disclosed methods may be implemented in connection with one or more software applications, including chatbot applications, customer-service systems, workflow automation platforms, data labeling systems, model training pipelines, model evaluation pipelines, or other machine-learning-enabled applications. The generated datasets, labels, semantic scores, threshold determinations, feedback signals, and associated metadata may be stored, indexed, versioned, audited, and retrieved for subsequent training, tuning, testing, benchmarking, governance, and model lifecycle management operations. It will therefore be appreciated that the disclosed technology may be realized in a wide range of computing environments and application contexts, and that the particular allocation of functionality between hardware and software components may vary from implementation to implementation without departing from the scope of the invention.

1. A computer-implemented method for automated dataset creation using a large language model, comprising:
a. utilizing a source large language model to generate counterfactual examples that represent incorrect or undesirable responses to given prompts;
b. labeling these counterfactual examples as negative examples;
c. using the negative examples to tune or test a target large language model to avoid generating semantically similar responses.

2. A computer-implemented method for automated dataset expansion using large language models, comprising:
a. Utilizing a source large language model to generate semantically equivalent variations of prompts and completions from an existing dataset;
b. Creating new prompt-completion pairs by combining original and perturbed elements;
c. Using the new prompt-completion pairs to tune and test a target large language model to recognize semantic equivalence across different phrasings.

3. The method as defined in claim 1, further comprising:
a. providing a source large language model;
b. providing a semantic analysis component for measuring proximity between original and generated examples;
c. providing a dataset management system for organizing and delivering labeled examples;
d. providing a target large language model that receives tuning and testing based on the generated dataset.

4. The method as defined in claim 2, further comprising:
a. providing a source large language model;
b. providing a semantic analysis component for measuring proximity between original and generated examples;
c. providing a dataset management system for organizing and delivering labeled examples;
d. providing a target large language model that receives tuning and testing based on the generated dataset.

5. The method according to claim 1, wherein semantic proximity is measured using embedding-based distance metrics.

6. The method according to claim 2, wherein semantic proximity is measured using embedding-based distance metrics.

7. The method according to claim 1, wherein the generation of examples is constrained by predetermined semantic similarity thresholds.

8. The method according to claim 2, wherein the generation of examples is constrained by predetermined semantic similarity thresholds.

9. The method according to claim 1, wherein the counterfactual examples are generated from a plurality of ground-truth prompt-completion pairs collected from one or more data sources, the ground-truth prompt-completion pairs comprising known and verified examples of input prompts and corresponding correct completions.

10. The method according to claim 9, wherein the ground-truth prompt-completion pairs are curated by human experts, derived from validated interaction logs, or sourced from authoritative datasets.

11. The method according to claim 1, wherein generating the counterfactual examples comprises generating one or more counterfactual completions for each prompt using one or more generation parameters of the source large language model.

12. The method according to claim 11, wherein the one or more generation parameters comprise temperature settings, sampling strategies, modified prompts, newly generated prompts, or combinations thereof.

13. The method according to claim 7, further comprising determining whether a measured semantic proximity of a generated counterfactual example falls within an acceptable semantic proximity window, and, responsive to a determination that the measured semantic proximity does not fall within the acceptable semantic proximity window, adjusting one or more generation parameters of the source large language model.

14. The method according to claim 8, further comprising determining whether a measured semantic proximity of a generated counterfactual example falls within an acceptable semantic proximity window, and, responsive to a determination that the measured semantic proximity does not fall within the acceptable semantic proximity window, adjusting one or more generation parameters of the source large language model.

15. The method according to claim 5, wherein the embedding-based distance metrics comprise cosine similarity.

16. The method according to claim 6, wherein the embedding-based distance metrics comprise cosine similarity.

17. The method according to claim 1, further comprising compiling a training dataset including the negative examples and corresponding positive examples derived from the ground-truth prompt-completion pairs, and training the target large language model using the training dataset.

18. The method according to claim 2, wherein generating semantically equivalent variations of prompts comprises generating perturbed prompts that preserve an original intent while varying phrasing, vocabulary, syntactic structure, level of detail, or combinations thereof.

19. The method according to claim 2, wherein generating semantically equivalent variations of completions comprises generating perturbed completions that preserve informational content and helpfulness while expressing a response using alternative linguistic formulations.

20. The method according to claim 2, wherein creating new prompt-completion pairs comprises pairing original prompts with perturbed completions, perturbed prompts with original completions, and perturbed prompts with perturbed completions, and validating each new prompt-completion pair for semantic consistency before inclusion in an expanded dataset.
